(19) United States
(12) Patent Application Publication
(10) Pub. No.: US 2014/0372015 A1
(43) Pub. Date: Dec. 18, 2014

(54) PUBLIC SAFETY VEHICLE ROUTING

(71) Applicant: MOTOROLA SOLUTIONS, INC., Schaumburg, IL (US)

(72) Inventor: Joseph C. NAMM, Plantation, FL (US)

(21) Appl. No.: 13/916,223

(22) Filed: Jun. 12, 2013

(51) Int. Cl. G01C 21/34

(52) U.S. Cl. CPC G01C 21/3407
USPC 701/117

(57) ABSTRACT

A method and apparatus for routing public-safety vehicles to an incident are provided herein. During operation a server will receive an emergency notification. In response, the server will determine an emergency type and vehicles that will be dispatched to the emergency. Routes will be tailored for each vehicle and then provided to each vehicle. The specifically-tailored routes will facilitate the arrival of vehicles on site in an appropriate order.

### FIELD OF THE INVENTION

The present invention generally relates to routing vehicles, and more particularly to a method and apparatus for routing public-safety vehicles to an incident.

### BACKGROUND OF THE INVENTION

Fire-ground incidents that require a multi-vehicle response will preferably have vehicles arriving at specific locations in a specific order to be most effective. For example, in situations that require the use of a ladder truck, it is desired to have the ladder truck maneuver directly to a building without being blocked by vehicles that arrived at an earlier time. Similarly, it is desirable to place all equipment on scene in a manner that allows, for example, fire equipment's access to a water supply. Thus, as is evident a need exists for a method and apparatus for routing public-safety vehicles to an incident that results in the vehicles arriving in an optimal order.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating a general operational environment, according to one embodiment of the present invention.

FIG. 2 illustrates a simplified map used to aide in understanding the operation of the present invention.

FIG. 3 is a block diagram of a dispatch center.

FIG. 4 is a flow chart showing operation of the dispatch center of FIG. 3.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a method and apparatus for routing public-safety vehicles to an incident are provided herein. During operation a server will receive an emergency notification. In response, the server will determine an emergency type and vehicles that will be dispatched to the emergency. Routes will be tailored for each vehicle and then provided to each vehicle. The specifically-tailored routes will facilitate the arrival of vehicles on site in an appropriate order.

More specifically, the server will determine a starting location for each vehicle and use local maps and traffic data to determine an optimal route for each vehicle. A route will then be provided to each vehicle so that the vehicles arrive on scene in a manner that reduces bottle necks and place the apparatus in the most optimum position based on apparatus type and role. With this in mind, assume that a ladder truck is being dispatched to a building along with several other vehicles. Additionally, assume that there is only one road accessing the building. The server may choose alternate routes for each vehicle dispatched to assure that the ladder truck arrives on scene first. Because each vehicle dispatched to a scene will have a specifically-tailored route, the vehicles can be better guaranteed to arrive on scene and placed in a most-efficient manner.

For example, a fire engine and a ladder truck are responding to the same incident. Based on initial proximity to the incident, the fire engine will arrive before the ladder truck and from the same general direction. In order to have optimum reach and effectiveness, the ladder truck must be placed in a location next to the structure ahead of the fire engine. The optimal route for the ladder truck, in this case, will be one that takes it past the incident so that it can arrive from another direction unobstructed by the fire engine. In this example the first arriving unit is not delayed and the ladder truck is still placed in the optimum location.

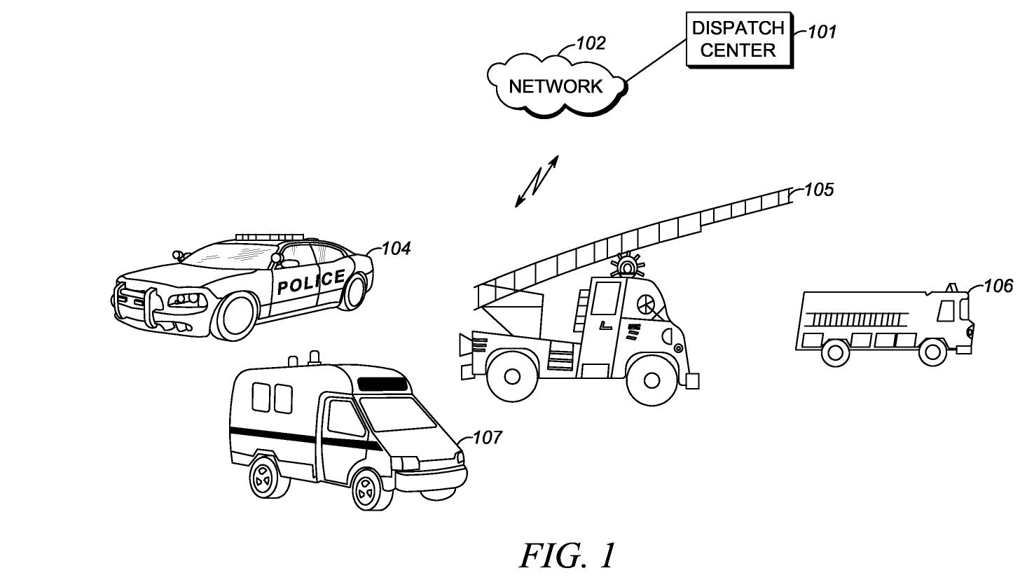

Turning now to the drawings wherein like numerals designate like components, FIG. 1 is a block diagram showing a general operational environment, according to one embodiment of the present invention. As shown in FIG. 1 a plurality of public-safety vehicles 104-107 are in communication with dispatch center 101 (serving as server 101) through intervening network 102. Public-safety vehicles 104-107 may comprise such vehicles as rescue vehicles, ladder trucks, ambulances, police cars, fire engines, . . . , etc. Network 102 may comprise one of any number of over-the-air or wired networks. For example network 102 may comprise a private 802.11 network set up by a building operator, a next-generation cellular communications network operated by a cellular service provider, or any public-safety network such as an APCO 25 network.

In this particular illustration the functionality of the above-described server is placed within dispatch center 101. Additionally, although only four public-safety vehicles 104-107 are shown, one of ordinary skill in the art will recognize that any number of vehicles may be routed to a particular incident. Finally, vehicles 104-107 may reside at a same location (starting point), or may be distributed geographically at differing locations (starting points).

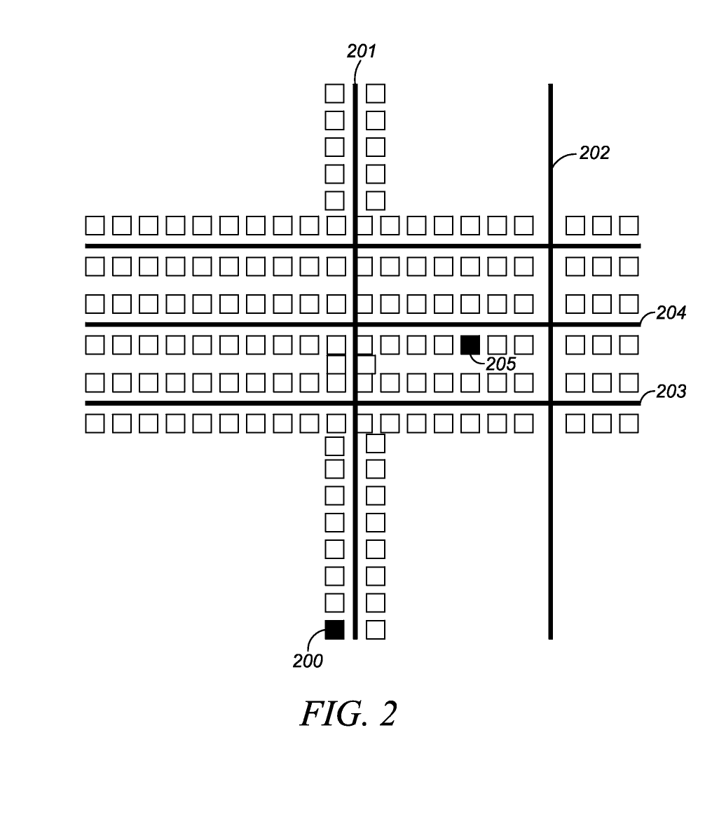

FIG. 2 illustrates a simplified map used to aide in understanding the operation of the present invention. With reference to FIG. 2, assume that multiple vehicles are located at point 200 and will be dispatched to an emergency located at building 205. Point 200 may comprise the location of, for example, a fire house. Dispatch center 101 will receive an emergency notification and a location of the emergency, for example, through a 911 call. In response, dispatch center 101 will determine those vehicles that will be dispatched to building 205 from point 200. If it is determined that a first vehicle should arrive on scene before other vehicles, the first vehicle may be directed down road 201 to road 204, while all other vehicles may be directed down road 201 to road 203 and ultimately to road 204. As is evident, the slightly longer route for the other vehicles will ensure that the first vehicle arrives on scene prior to the others.

Further expanding on the above, there may exist a situation where multiple vehicles are routed to point 205 using multiple routes in an attempt to have the multiple vehicles arrive on scene at multiple times. For example, it may be advantageous to have police arrive on scene first, followed by a ladder truck, followed by an ambulance, . . . , etc. In this case, all vehicles may have a specifically-tailored route that differs from point 200 to point 205.

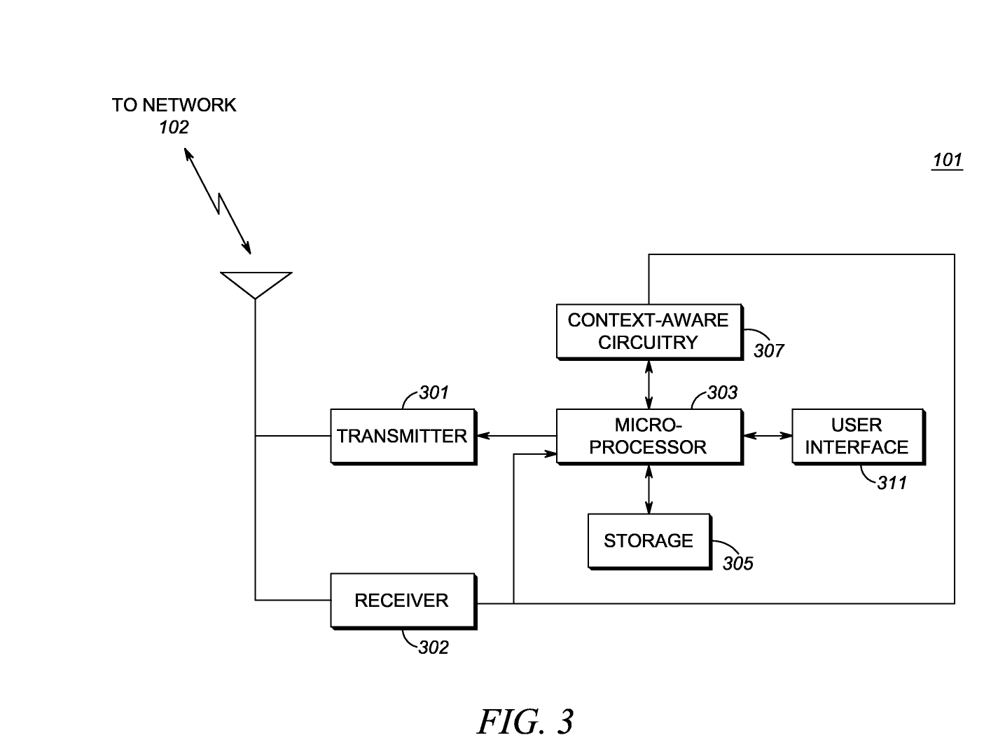

FIG. 3 is a block diagram of dispatch center 101. Dispatch center 101 typically comprises processor 303 (sometimes referred to as a microprocessor, logic unit, or logic circuitry) that is communicatively coupled with various system components, including transmitter 301, receiver 302, general storage component (database) 305, context-aware circuitry 307, and user interface (GUI) 311. Only a limited number of system elements are shown for ease of illustration; but additional such elements may be included in the dispatch center 101.

Processing device 303 may be partially implemented in hardware and, thereby, programmed with software or firmware logic or code for performing functionality described in FIG. 3; and/or the processing device 303 may be completely implemented in hardware, for example, as a state machine or ASIC (application specific integrated circuit). Storage 305 can include short-term and/or long-term storage of various information needed for the recall of specific knowledge to aide in routing vehicles. For example, storage 305 may comprise maps along with vehicle priorities (e.g., a priority of a vehicle to arrive on scene). Storage 305 may further store software or firmware for programming the processing device 303 with the logic or code needed to perform its functionality.

User interface 311 receives an input from a user that may be used to route vehicles accordingly. For example, user interface 311 provides a way of inputting a type of emergency event along with an address of the emergency event. In an embodiment, event information may be displayed to the user of equipment 101 along with vehicles dispatched. In order to provide the above features (and additional features), user interface 311 may include a keypad, a display/monitor, a mouse/pointing means, and/or various other hardware components to provide a man/machine interface.

In a first embodiment, context-aware circuitry 307 preferably comprises circuitry that determines traffic conditions. For example, context-aware circuitry 105 may comprise a receiver that receives current traffic conditions from a subscribed service, for example, Google™ Maps. Logic circuitry 303 will use information generated by circuitry 307 to determine appropriate routes to emergency events. Context-aware circuitry is also utilized to determine a location for various emergency vehicles. For example, each emergency vehicle may be equipped with a GPS receiver that will be utilized to determine the vehicle's location. This information may be received by receiver 302 and provided directly to context-aware circuitry or through processor 303 so that the location of emergency vehicles can be readily obtained.

Transmitter 301 and receiver 302 are common circuitry known in the art for communication utilizing a well known communication protocol, and serve as means for transmitting and receiving messages. For example, receiver 302 and transmitter 301 may be well known long-range transceivers that utilize the Apco 25 (Project 25) communication system protocol. Other possible transmitters and receivers include, IEEE 802.11 communication system protocol, transceivers utilizing Bluetooth, HyperLAN protocols, or any other communication system protocol.

In a preferred embodiment processor 303 receives a notification from user interface 311 that an event or condition has occurred along with an address of the event. (Note that the notification may be part of an automated process and need not be inputted to controller 303 via user interface 311). Storage 305 is accessed to determine what vehicles are needed to be dispatched to the event along with a priority of each vehicle. (Those vehicles with higher priorities will arrive on scene first). A map is obtained from storage 305 and context-aware circuitry 307 is utilized to determine any traffic condition that may affect travel times to the event. Logic unit 303 then accesses the location of each emergency vehicle using context aware circuitry 307. Based on the location of each vehicle, the priority of each vehicle, and the traffic conditions, logic unit 303 then calculates a specifically tailored route for each vehicle so that the vehicles arrive on scene in an appropriate order. Transmitter 301 is then utilized to provide each vehicle with its route to the scene.

Calculation of Routes:

Routes will be calculated for each responding apparatus/vehicle within a single or distributed networked server. As each apparatus is dispatched to an incident (and subsequently responds), the current location, time of day, known traffic congestion/hazards, apparatus type, crew capability, and intended/required role (search and rescue, fire attack, HazMat, etc.) is determined. The role is determined by apparatus type and incident requirements. The assigned role of each apparatus is then used to virtually locate the terminal position of the apparatus at the incident. A route is then determined which would place each apparatus at their respective terminal position in the most efficient manner and least interaction with other responding apparatus. (A side effect of this is collision avoidance with other apparatus, which has been an issue in the past). Routes would be continually/periodically updated based on all responding apparatus' current location.

For example, a fire department may have a standard procedure to respond 4 engines to a house fire. Each responding engine has a specific role such as 1^{st} engine would perform initial fire attack, 2^{nd} engine would supply the 1^{st} with water from the hydrant, 3^{rd} would be assign to search the structure, 4^{th} would be assigned to standby. In this example, the 1^{st} engine would be placed so that its hoses would have the farthest reach into the structure. The 2^{nd} engine would need to approach the scene so that the closest hydrant can be used. The 3^{rd} and 4^{th} engine placement is not critical so they should be placed so that any rescue vehicles would have the best access.

In another example, it may be the standard procedure to initially respond 6 fire engines and 2 aerial trucks to a high rise structure fire. Aerial trucks need to be located in specific pre-determined locations so their aerial ladders can have the most effective reach for rescue or fire attack. Since the tasks of the fire engine crews is mostly manpower, the engines need to drop off the crews close to the structure and ultimately be located away from the structure so they do not impend aerial operations. Since placement of the aerials has priority the engines' routes would be such that they would not interfere with the placement of the aerial trucks.

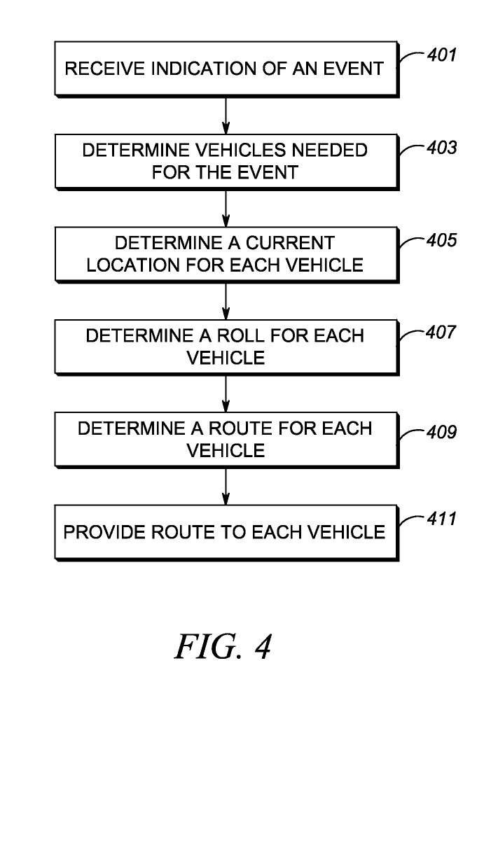

FIG. 4 is a flow chart showing operation of dispatch center 101 acting as a server. The logic flow begins at step 401 where logic circuitry 303 receives an indication of an event. As discussed above, the event may comprise a public-safety incident such as, but not limited to a fire, a crime, or an injury. In response, logic circuitry 303 accesses storage 305 to determine vehicles needed for the event (step 403). At step 405 context-aware circuitry 307 is accessed to determine a current location of each vehicle. Circuitry 307 may receive this information wirelessly from receiver 302, or may poll each vehicle with transmitter 301 prior to receiving the information. At 407 a roll for each vehicle is then determined by logic circuitry 303. This step may simply be determined from the type of vehicle responding (e.g., ladder truck, hose truck, ambulance, . . ., etc.) or may be determined by accessing stored information on each vehicle (from storage 305). Regardless of how this information is determined, the role for each vehicle comprises a function the vehicle will perform when the vehicle arrives at the scene.

At step 409 a route for each vehicle is determined by logic circuitry 303 based on the type of event, the current location of each vehicle, and the role of each vehicle. Finally, at step 411 logic circuitry 303 utilizes transmitter 301 to transmit the route to each vehicle.

It should be noted that in addition to the route each vehicle will take to the scene, logic circuitry 303 may also determine a position at the scene where each vehicle will be located. Position information may also be stored in storage 305. The step of determining the route for a particular vehicle may additionally be based on the position at the scene of the particular vehicle.

In addition to the steps described above, logic circuitry 303 may also access context-aware circuitry 307 to determine traffic conditions. The step of determining the route for a particular vehicle may additionally be based on the traffic conditions experienced by the particular vehicle.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for dispatching vehicles to a scene, the method comprising the steps of:
receiving, at a server, an indication of an event;
determining vehicles needed for the event;
determining a current location of each vehicle;
determining a role for each vehicle;
determining a route for each vehicle based on the type of event, the current location of each vehicle, and the role of each vehicle.

2. The method of claim 1 further comprising the step of:
transmitting the route to each vehicle.

3. The method of claim 2 wherein the server comprises a public-safety dispatch center.

4. The method of claim 3 wherein the vehicles comprise public-safety vehicles including fire equipment.

5. The method of claim 4 wherein the role for each vehicle comprises a function the vehicle will perform when the vehicle arrives at the scene.

6. The method of claim 1 further comprising the step of:
determining a position at the scene where each vehicle will be located; and
wherein the step of determining the route for a particular vehicle is additionally based on the position at the scene of the particular vehicle.

7. The method of claim 1 further comprising the steps of:
determining traffic conditions; and
wherein the step of determining the route for a particular vehicle is additionally based on the traffic conditions experienced by the particular vehicle.

8. The method of claim 1 wherein the step of determining the current location of each vehicle comprises the step of utilizing a receiver to wirelessly receive the current location from each vehicle.

9. The method of claim 1 wherein the type of event comprises a fire.

10. An apparatus comprising:
context-aware circuitry determining a location for a plurality of vehicles;
logic circuitry receiving an indication of an event, determining vehicles needed for the event, determining a role for each vehicle, and determining a route for each vehicle based on the type of event, the current location of each vehicle, and the role of each vehicle.

11. The apparatus of claim 10 further comprising:
a transmitter transmitting the route to each vehicle.

12. The apparatus of claim 11, wherein the apparatus comprises a public-safety dispatch center.

13. The apparatus of claim 12 wherein the vehicles comprise public-safety vehicles including fire equipment.

14. The apparatus of claim 13 wherein the role for each vehicle comprises a function the vehicle will perform when the vehicle arrives at the scene.

15. The apparatus of claim 10 further comprising:
a database storing a position at the scene where each vehicle will be located; and
wherein the logic circuitry determines the route for a particular vehicle based on the position at the scene of the particular vehicle.

16. The apparatus of claim 10 wherein:
the context-aware circuitry determines traffic conditions; and
wherein the logic circuitry determines the route for a particular vehicle based on the traffic conditions experienced by the particular vehicle.

17. The apparatus of claim 10 wherein the location of each vehicle is received wirelessly from each vehicle.

18. The apparatus of claim 1 wherein the type of event comprises a fire.
